(19) United States
(12) Patent Application Publication
(10) Pub. No.: US 2024/0253960 A1
(43) Pub. Date: Aug. 1, 2024

(54) LIFT DEVICE

(71) Applicant: Bruns Holding GmbH & Co. KG, Apen (DE)

(72) Inventor: Gerit Bruns, Bad Zwischenahn (DE)

(21) Appl. No.: 18/426,834

(22) Filed: Jan. 30, 2024

(30) Foreign Application Priority Data
Jan. 30, 2023 (DE) 202023100421.0

(51) Int. Cl. B66F 7/28; B66F 7/08

(52) U.S. Cl. CPC B66F 7/28; B66F 7/08

(57) ABSTRACT

A lift device is provided for vehicles for wheelchair users, the lift device including a roll-over flap, a lifting platform, and a support arm. The support arm has a first sub-arm (12) and a second sub-arm which are rotatably coupled to one another. The second sub-arm is rotatably connected to the lifting platform and the roll-over flap, and the lift device is configured to extend or retract the roll-over flap and to lock it in at least one position. The extending or retracting and the locking are carried out according to the position of the lifting platform and the support arm.

### CROSS-REFERENCE TO RELATED APPLICATION

This application claims priority to, German Application No. 202023100421.0, filed Jan. 30, 2023, with the same title as listed above. The above-mentioned patent application is incorporated herein by reference in its entirety.

### TECHNICAL FIELD

This application relates to a lift device, in particular to a lift device for wheelchair users. This application also relates to a vehicle, in particular to a vehicle for transporting passengers with reduced mobility.

### BACKGROUND

Lift devices generally have a lifting platform which is configured to accommodate a person, in particular a wheelchair user, and to raise the person to different height levels. The lift device is mounted on a vehicle, preferably at the rear or at one side, in such a way that the person sitting on a wheelchair can be brought into or out of the vehicle. To achieve that purpose, the lift has a platform that can be raised and lowered between a ground level and a higher vehicle level. Such a device is known, for example, from EP Patent No. 2641576, which is held by the present applicant. Similar lifts are known from US Patent Publication No. 2007/0071569 A1, U.S. Pat. No. 11,504,285 B2 or U.S. Pat. No. 7,441,995 B2.

Such lift devices typically have a rotatably mounted roll-over flap as well. The function of the latter is firstly to form a safety boundary, preferably in a substantially vertical orientation, while lifting a wheelchair user, for example, from an initial loading position. Secondly, a roll-over flap is often extended by a mechanism such that a roll-over bridge is created between the lift platform and the vehicle floor in the raised entry position, thus allowing a wheelchair user to enter the vehicle easily by rolling the wheelchair over the flap.

Lift devices of the kind described above often have a support arm structure for raising the lift platform. The mechanism for operating the roll-over flap can be coupled to the movement of the support arm structure, for example via additional arm structures, hoisting cables and/or deflection pulleys, the roll-over flap being retracted or extended according to the position of the arm structure. Reliable operation, where the roll-over flap is locked in the retracted position, is often difficult to implement.

### SUMMARY

Thus, it would be desirable to provide a lift device with an improved mechanism for actuating or locking the roll-over flap.

According to a first set of embodiments, the invention achieves its object with a lift device for vehicles for wheelchair users. The lift device includes a roll-over flap, wherein the roll-over flap is mounted rotatably relative to a lifting platform, a lifting platform for loading with a load, a support arm for raising and lowering the load to a desired position, wherein the support arm has a first sub-arm and a second sub-arm which are rotatably coupled to one another, and wherein the second sub-arm of the support arm is rotatably connected to the lifting platform and the roll-over flap, wherein the lift device is configured to extend or retract the roll-over flap and to lock it in at least one position, wherein the extending or retracting and the locking are carried out according to the position of the lifting platform and the support arm, wherein a telescopic rod is configured with a first inner rod, a second outer rod and a spring, and a locking means is provided, wherein the locking means is disposed on the telescopic rod and is configured to lock the roll-over flap, wherein the locking means is designed as a pawl, and the pawl engages with the telescopic rod in such a way during locking that the first inner rod of the telescopic rod is no longer movable relative to the second outer rod, and the inner rod of the telescopic rod has a projection or piston, wherein the pawl locks the projection or piston during locking.

According to a second set of embodiments of the invention, the object is achieved by a lift device for vehicles for wheelchair users, including a roll-over flap, wherein the roll-over flap is mounted rotatably relative to a lifting platform, a lifting platform for loading with a load, a support arm for raising and lowering the load to a desired position, wherein the support arm has a first sub-arm and a second sub-arm which are rotatably coupled to one another, and wherein the second sub-arm of the support arm is rotatably connected to the lifting platform and the roll-over flap, wherein the lift device is configured to extend or retract the roll-over flap and to lock it in at least one position, wherein the extending or retracting and the locking are carried out according to the position of the lifting platform and the support arm, wherein the locking of the roll-over flap is caused by the weight balance of a component that exerts a torque on the component, which moves and/or biases a locking means into the locking position to lock the roll-over flap in a locked position.

According to this set of embodiments of the invention, a component is balanced and preferably rotatably mounted in such a way that a locking means is forced or biased into a locking position due to a weight force, with the result that the roll-over flap is locked in a locked position. The component is rotatably mounted, in particular, and a torque that biases the locking means into a locking position is produced on the component by the weight balance.

According to a preferred development of the invention, the lift device has a pull rod which is configured to actuate the locking means according to the orientation of the support arm. The weight balance is preferably achieved by the component being a stop member with a slider, which is rotatably connected to the telescopic rod and the pull rod and is rotatably connected via a bar to the second sub-arm of the support arm, wherein the stop member with the slider rests against the first sub-arm of the support arm and, by changing the angle between the two sub-arms of the support arm, transfers a force to the pull rod, thus actuating the locking means.

It is also preferred that the slider is attached rotatably or pivotably by a rotary joint to the telescopic rod, in particular to its upper, outer rod, such that the slider can be positioned in different rotational positions relative to the support arm.

The weight balance for biasing the locking means or the pawl into a locking position is also produced, particularly preferably, by a section of the slider on one side of the rotary joint being longer and/or heavier than the section at the opposite end of the slider.

According to a preferred development of the invention, the locking means is designed as a pawl.

According to another embodiment of the invention, the pawl engages with the telescopic rod in such a way during locking that the inner rod of the telescopic rod is no longer movable relative to the outer rod. This results in a self-locking mechanism with little wear on the locking means or the pawl.

According to a preferred development of the invention, the inner rod of the telescopic rod has a piston, wherein the pawl locks the piston during locking. When doing so, the pawl does not engage with a hole inside the inner rod of the telescopic rod, but is connected instead to the outer contour of the piston, thus allowing the reliability of the locking mechanism to be increased.

According to another preferred development of the invention, the lift device has a pull rod which is configured to actuate the locking means according to the orientation of the support arm. Via the pull rod, the necessary mechanical coupling to the support arms can be set up, depending on which the locking means locks or unlocks the telescopic rod and thus the roll-over flap.

According to a preferred development of the invention, the lift device has a stop member with a slider, which is rotatably connected to the telescopic rod and the pull rod and is rotatably connected via a bar to the second sub-arm of the support arm, wherein the stop member with the slider rests against the first sub-arm of the support arm and, by changing the angle between the two sub-arms of the support arm, transfers a force to the pull rod, thus actuating the locking means. When the lifting platform is lowered by the support arm, the angle between the support arms increases and the slider moves along the surface of the upper sub-arm. This produces a pulling force on the pull rod, as a result of which the pawl actuates and the roll-over flap is locked.

According to another embodiment of the invention, the lift device has a handle to hold onto for the person or object to be lifted, and which is attached, with limited rotatability relative to the bar and the second sub-arm of the support arm, at the attachment point of the bar to the second sub-arm of the support arm. The handle is used to secure a person sitting in a wheelchair, for example.

According to a preferred development of the invention, the lift device has a roll-over flap guide which is rotatably connected to the telescopic rod and the roll-over flap.

According to another embodiment of the invention, the roll-over flap guide has an elongate hole and is connected to the telescopic rod via the elongate hole. A screw connection or some other kind of connection can slide along the elongate hole during movement of the lift device or the roll-over flap.

The roll-over flap guide allows the extending and retracting of the roll-over flap to be guided precisely.

Further embodiments of the invention relate to a vehicle, in particular to a vehicle for transporting persons with reduced mobility, having a lift device, in particular a lift device for wheelchair users, including a roll-over flap, a lifting platform for loading with a load, wherein the roll-over flap is rotatably connected to the lifting platform, a support arm for raising the load to a desired position, wherein the support arm has a first sub-arm and a second sub-arm which are rotatably connected to one another, and wherein the second sub-arm of the support arm is rotatably connected to the lifting platform and the roll-over flap, wherein the lift device is configured to extend or retract the roll-over flap and to lock it, wherein the extending or retracting and the locking are carried out according to the position of the lifting platform and the support arm.

### BRIEF DESCRIPTION OF THE DRAWINGS

Further advantages, features and possible applications of the present invention will be apparent from the following detailed description in connection with the drawings. The accompanying drawings, which are incorporated in and constitute a part of this specification, illustrate one of more embodiments of the invention and, together with the general description given above and the detailed description given below, explain the one or more embodiments of the invention.

FIG. 1 is a schematic, overall perspective view of a first embodiment of the lift device according to the invention, with a typical, schematically indicated vehicle to which the lift device can be attached and is attached when in operation.

FIG. 2 is a schematic side view of an embodiment of the lift device according to the invention.

FIG. 3 is a schematic perspective view of components of an embodiment of the lift device according to the invention in a first actuating position.

FIG. 4 is a schematic view of the components shown in FIG. 3, in a second actuating position, in a first perspective view.

FIG. 5 is a second perspective view of the components in the second actuating position as shown in FIG. 4.

FIG. 6 shows the components in the second actuating position as shown in FIG. 4, in a perspective view of a detail in the region of the outer telescopic rod.

FIG. 7 is a perspective cross-sectional view of the components shown in FIG. 4.

FIG. 8 shows a detail of the components shown in FIG. 7, in the region of the pawl.

FIG. 9 is a schematic side view of an embodiment of the lift device according to the invention in a first position.

FIG. 10 is a schematic perspective view of the lift device shown in FIG. 9.

FIG. 11 is a schematic side view of an embodiment of the lift device according to the invention in a second position.

FIG. 12 is a schematic perspective view of the lift device shown in FIG. 11.

FIG. 13 is a schematic side view of an embodiment of the lift device according to the invention in a third position.

FIG. 14 is a schematic perspective view of the lift device shown in FIG. 13.

FIG. 15 is a schematic side view of an embodiment of the lift device according to the invention in a fourth position.

FIG. 16 is a schematic perspective view of the lift device shown in FIG. 15.

FIG. 17 is a schematic side view of an embodiment of the lift device according to the invention in a fifth position.

FIG. 18 is a schematic perspective view of the lift device shown in FIG. 17.

FIG. 19 is a schematic side view of an embodiment of the lift device according to the invention in a sixth position.

FIG. 20 is a schematic perspective view of the lift device shown in FIG. 19.

FIG. 21 shows a second embodiment of the lift device according to the invention in a side view in which a slider acquires a torque due to its weight balance.

FIG. 22 shows the embodiment according to FIG. 21 in a perspective view.

FIG. 23 shows the embodiment according to FIG. 21 in a partial view with a slider and rod.

FIG. 24 is a side view of the embodiment according to FIG. 21 in a position with a pivoted slider.

FIG. 25 is a perspective view of the embodiment according to FIG. 21.

### DETAILED DESCRIPTION

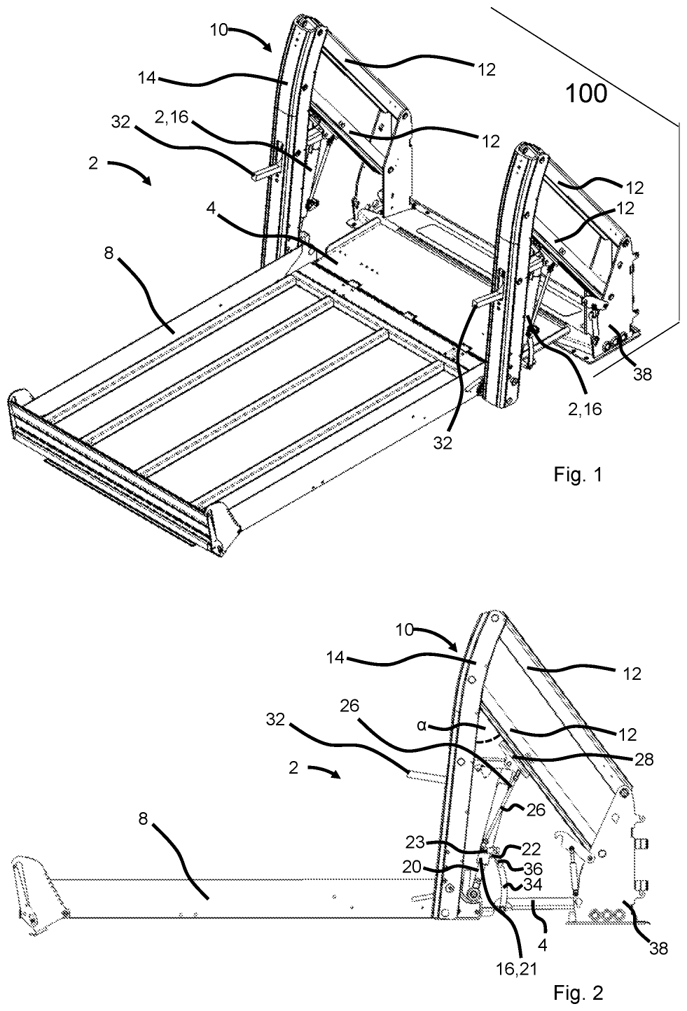

FIG. 1 shows an embodiment of lift device 2 according to the invention, with a roll-over flap 4 and a platform or lifting platform 8 for loading with a load, in particular for a person sitting in a wheelchair. Lift device 2 is attached to a vehicle 100 in a typical manner, preferably at the rear of the vehicle. Vehicle 100 according to the invention, with lift device 2 attached thereto, is shown here in schematic form only, as it is known per se.

Roll-over flap 4 is rotatably mounted, and in the embodiment is rotatably connected to lifting platform 8. In a substantially horizontal arrangement, roll-over flap 4 serves to form a bridge between lifting platform 8 and vehicle 100 so that a wheelchair carrying a person can be well transported along it. In a vertical or inclined, locked position, roll-over flap 4 serves as a barrier to prevent the wheelchair from rolling off the lifting platform while the lift is being raised or lowered. The aim of the locking mechanism is to ensure that this safety is provided even under greater loads, as in the case of electric wheelchairs, for example. In this latter position, roll-over flap 4 is also to be securely positioned or locked so that it does not drop down inadvertently.

An operable support arm 10 is provided for lifting a load positioned on lifting platform 8 to a desired position, wherein support arm 10 is embodied in multiple parts in the initial example and has a first sub-arm 12 and a second sub-arm 14 which are rotatably connected to one another, and wherein the second sub-arm 14 of support arm 10 is rotatably connected to lifting platform 8 and roll-over flap 4. Lift device 2 is configured to extend or retract roll-over flap 4 and to lock it, wherein the extending or retracting and the locking are carried out according to the position of lifting platform 8 and support arm 10. Support arm 10 is designed as a parallelogram linkage mechanism and is driven, in a manner that is known per se and not shown in further detail, by an hydraulic cylinder or the like, so as to be able to raise or lower lifting platform 8. Reference is made in this respect to the applicant's U.S. Pat. No. 9,814,635, the entire content of which is incorporated by reference into the present disclosure, particularly with regard to actuation of the support arm.

Lift device 2 also has a telescopic rod 16, wherein a first rod 20 is provided that can be moved axially relative to the second rod 21. Lift device 2 also has handles 32. Support arm 10 is connected to the vehicle structure of vehicle 100 via a mounting 38 (see FIG. 1).

FIG. 2 illustrates further components of the lift device 2 shown in FIG. 1. Telescopic rod 16 has a first, preferably inner rod 20 and a second, preferably outer rod 21. Locking means or pawl holder 23 with pawl 22 is rotatably attached to telescopic rod 16. Pull rod 26 is attached to pawl holder 23 and is also connected to a stop member that has a slider 28. Roll-over flap guide 34 with elongate hole 36 is likewise attached rotatably to telescopic rod 16. Stop member 28 with slider 28 rests against upper sub-arm 12.

Slider 28 can also be referred to as a sliding shoe. It can be brought into contact with sub-arm 12 of support arm 10 and slide along its surface. Slider 28 is also attached rotatably or pivotably by a rotary joint 29 to telescopic rod 16, in particular to its upper, outer rod 21, such that slider 28 can be positioned in different rotational positions relative to support arm 10.

When lifting platform 8 is lowered by actuating support arm 10, comprising the first sub-arm 12 and the second sub-arm 14, by an hydraulic cylinder or the like, the angle α between sub-arms 12 and 14 changes, and the stop member with slider 28 produces a pulling force on pull rod 26 during the rotational movement. This causes a rotational movement of pawl holder 23, thus causing pawl 22 to be brought closer to the locking position in which pawl 22 locks the inner rod 20 of telescopic rod 16. The opposite effect is produced when lifting platform 8 is raised. Support arm 10 can thus be locked in such a way that roll-over flap 4 is positioned in its passive, substantially vertical or inclined position and is fixed or locked in place, i.e., in a locking position.

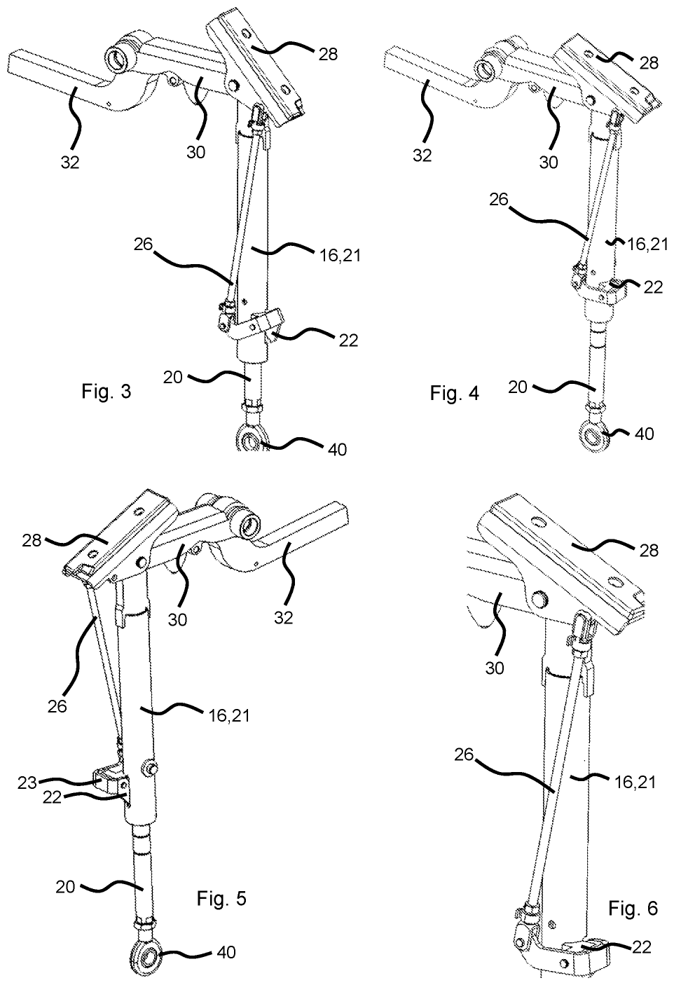

FIG. 3 shows the exact structure and connections of components of lift device 2 according to the invention as shown in FIG. 1. Telescopic rod 16 with its inner rod 20 and its outer rod 21, the stop member with slider 28, pull rod 26, pawl 22 and handle 32 can all be seen. Stop member with slider 28 has a rotatable connection to the outer rod 21 of telescopic rod 16, and a rotatable connection, at the same attachment point, to a bar 30 which for its part is rotatably connected to the first sub-arm 12 of support arm 10. Bar 30 can be regarded as a component of a rocker that orients itself according to the angular position of sub-arms 12 and 14 relative to each other. Handle 32 is likewise connected to bar 30 and is rotatably attached to the same attachment point of bar 30 to the second sub-arm 14. In addition to the attachment point at the stop member with slider 28, as described above, the latter also has an attachment point to pull rod 26. In order to attach the inner rod 20 of telescopic rod 16 to lifting platform 8, the former has an attachment member 40 similar to a screw eye.

The manner of operation and the structure of device 2 and of the locking and unlocking mechanism are further illustrated in FIGS. 3-8.

FIG. 4, for example, shows the components shown in FIG. 3 in a locking position of pawl 22. The (rotational) position of the stop member with slider 28 has been changed via sub-arms 12 and 14 such that a pulling force has acted on pull rod 26, with the result that pawl holder 23 has been rotated, and pawl 22 has been guided into the corresponding locking position.

FIG. 5 shows the locking position shown in FIG. 4 in a second perspective in which the engagement point of pawl 22 is shown more clearly. FIG. 6 shows an enlarged view of how the pull rod is attached and how it functions.

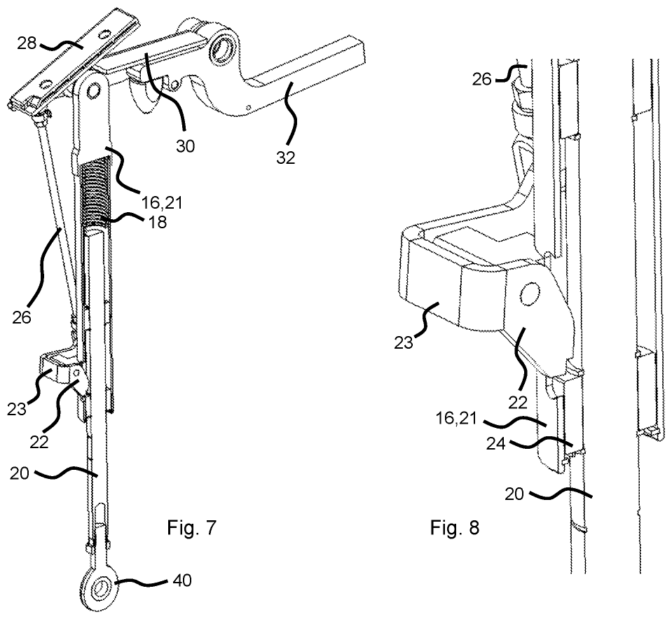

FIG. 7 shows a cross-sectional view of the components shown in FIG. 4, with telescopic rod 16 and components connected to telescopic rod 16. Spring 18, which exerts a compressive force on the inner rod 20 of telescopic rod 16, is arranged inside telescopic rod 16. Attachment member 40 similar to a screw eye is attached to inner rod 20. The arrangement of handle 32 in relation to bar 30 is also shown clearly. Bar 30 is designed as a hollow profile, with handle 32 located partly inside the hollow profile.

FIG. 8 illustrates the structure, in the region of pawl 22, of the lift device 2 shown in FIG. 4. Inner rod 20 is partly inserted into the outer rod 21 of telescopic rod 16, and a piston 24 is attached to inner rod 20. The profile of pawl 22 is designed in such a way that the pawl rests against piston 24 on locking. In this locked position, piston 24 and inner rod 20 are prevented from performing an upward movement, which in turn prevents inner rod 20 from being pushed into telescopic rod 16, thus preventing roll-over flap 4 from being extended due to movement of roll-over flap guide 34.

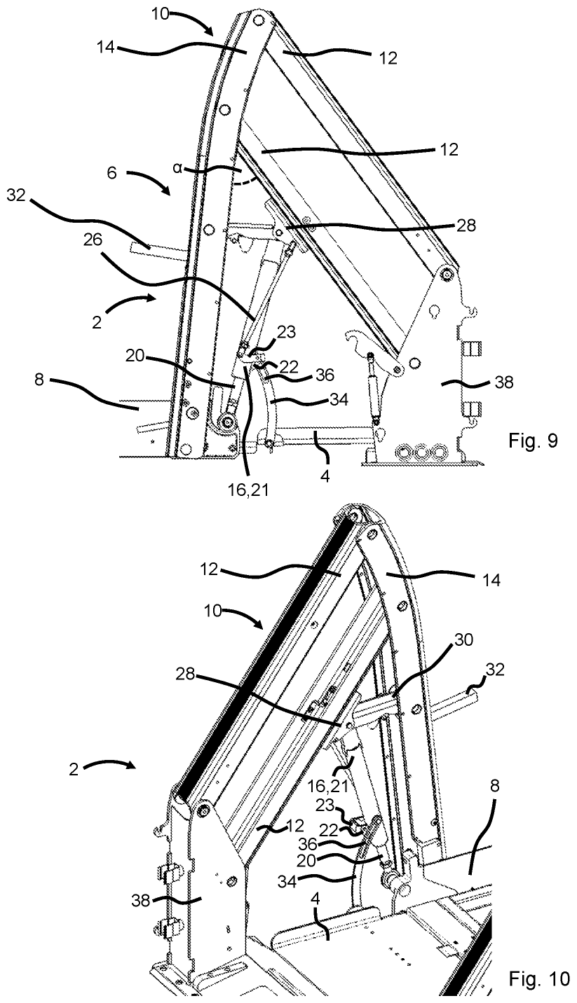

The sequence of movements during locking by pawl 22 is illustrated again in FIGS. 9-20. Different positions of lifting platform 8, of support arm 10 and of lift device 2, starting in an upper position with extended roll-over flap 4, are shown from two perspectives in each case.

In FIG. 9 and FIG. 10, lift device 2 is in the upper position, where roll-over flap 4 is extended and a bridge is formed between lifting platform 8 and vehicle 100. In this position, it is possible, for example, for a wheelchair user to enter the interior of vehicle 100. It can also be seen that pawl 22 is in an unlocked position due to pull rod 26. Inner rod 20 is inserted relatively deep into the outer rod 21 of telescopic rod 16, such that roll-over flap guide 34 allows roll-over flap 4 to be in its extended position. In this position, the stop member with slider 28 is in full contact with upper sub-arm 12. Sub-arms 12 and 14 form an angle α that is relatively small in this case.

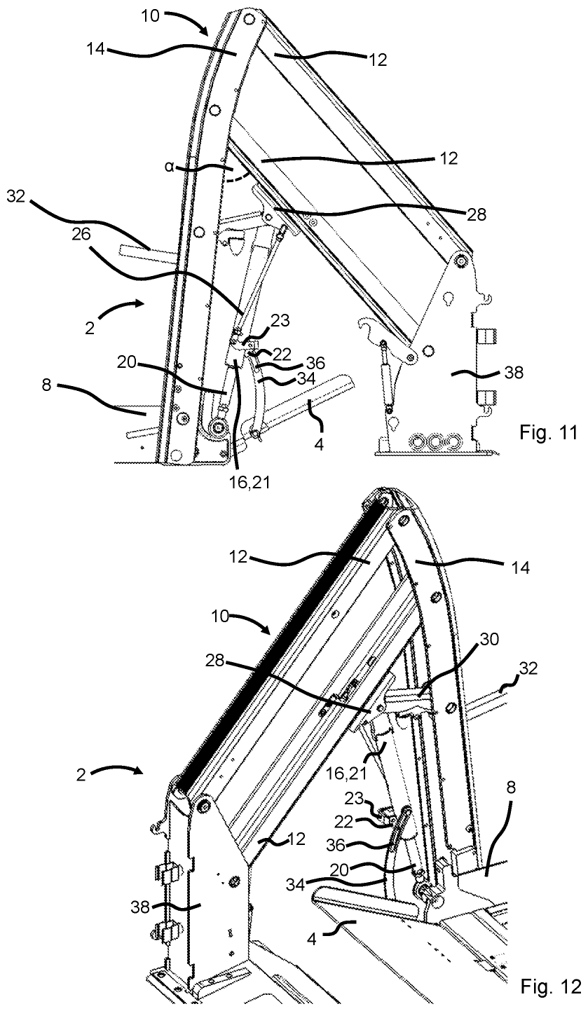

FIG. 11 and FIG. 12 show a position when lift device 2 is starting to be lowered. As the angle α between the two sub-arms 12 and 14 has increased here in relation to the previous position shown in FIG. 9 and FIG. 10, inner rod 20 has been pulled further out of outer rod 21, such that roll-over flap guide 34 is starting here to retract roll-over flap 4. At the same time, due to the rotational movement of the upper sub-arm in particular, there is a rotational and sliding movement of the stop member with slider 28, with a pulling force being exerted on pull rod 26 due to the sliding movement and the rotation about the attachment point between the stop member with slider 28, and outer rod 21 and bar 30. This starts the rotation of pawl holder 23 and the actuation of pawl 22 and the locking operation.

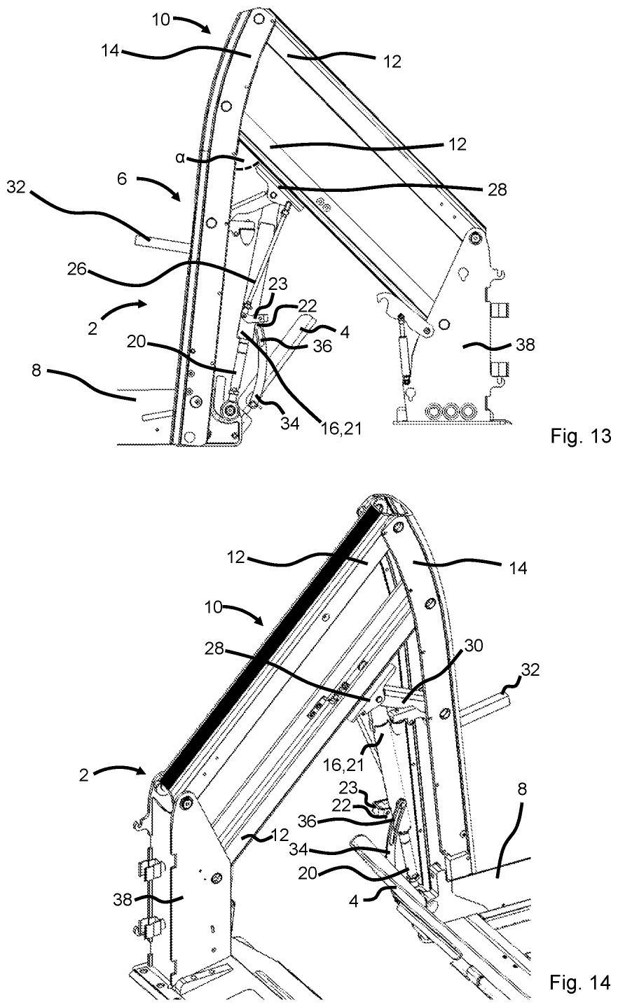

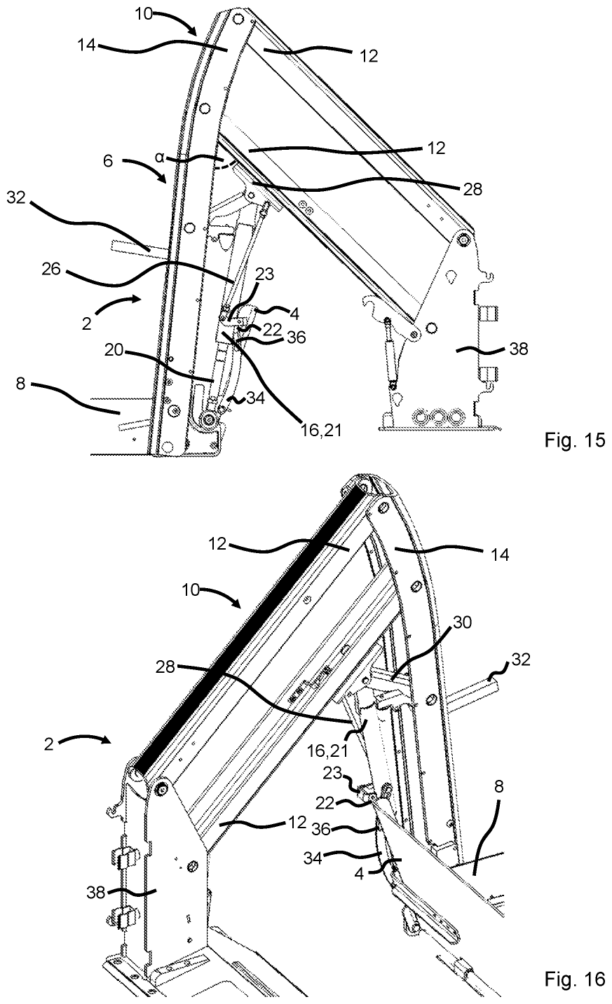

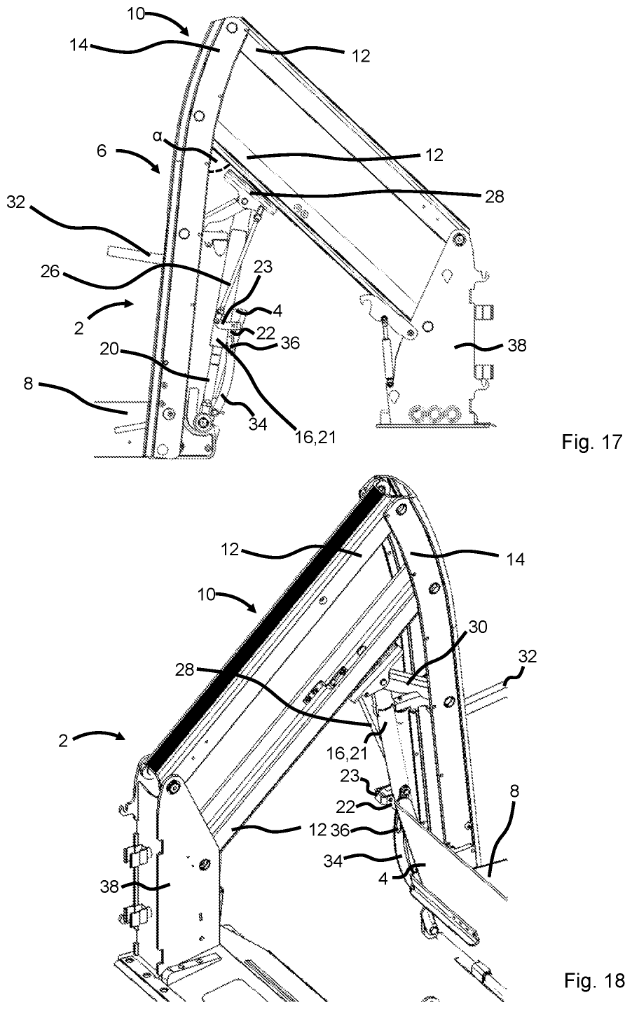

In FIG. 13 and FIG. 14, FIG. 15 and FIG. 16, and FIG. 17 and FIG. 18, angle α increases steadily while lifting platform 8 is lowered further. In FIG. 15 and FIG. 16, roll-over flap 4 has been retracted by roll-over flap guide 34, while inner rod 20 has been pulled out to its maximum extent. As the inner rod 20 of telescopic rod 16 in FIG. 15 and FIG. 16 cannot be pulled out any further, stop member with slider 28 is lifted partly off the surface of upper sub-arm 12 while the lifting platform is lowered further. This causes further rotation of the stop member with slider 28 about the attachment point to telescopic rod 16 and to bar 30, described above, and a pulling force continues to act on pull rod 26. Pawl 22 is guided/rotated further towards the locking position.

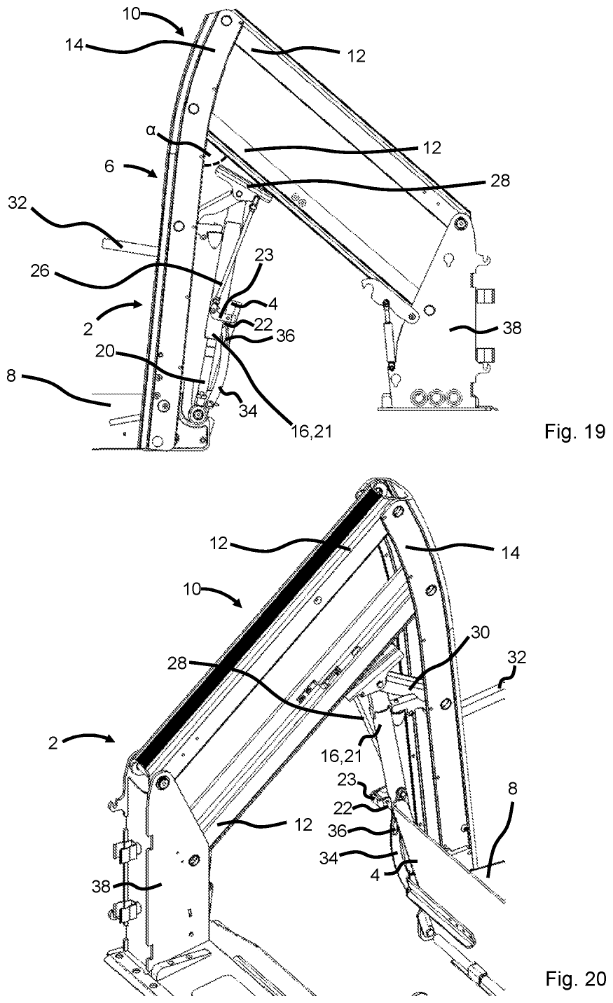

The locking position is reached in FIG. 19 and FIG. 20. It can be seen that the stop member with slider 28 has turned further away from the surface of sub-arm 12 and has rotated about the attachment point described, with the result that pawl 22 is in the locking position.

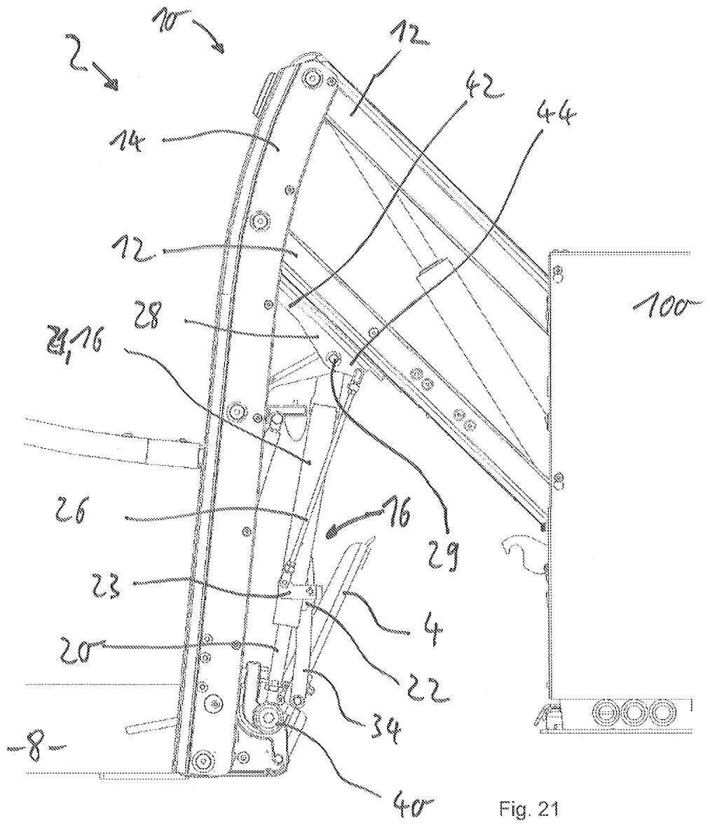

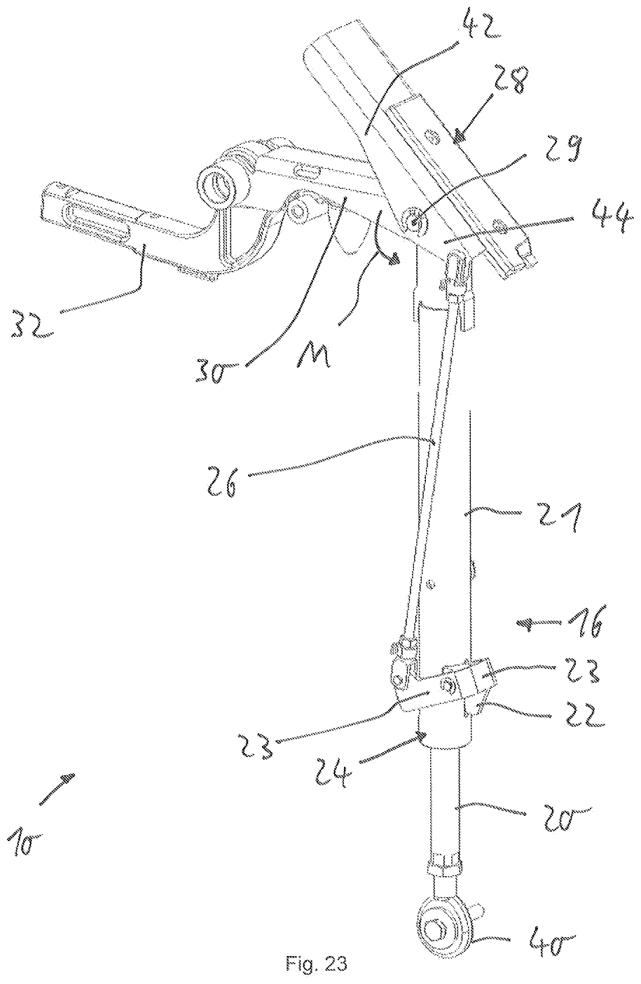

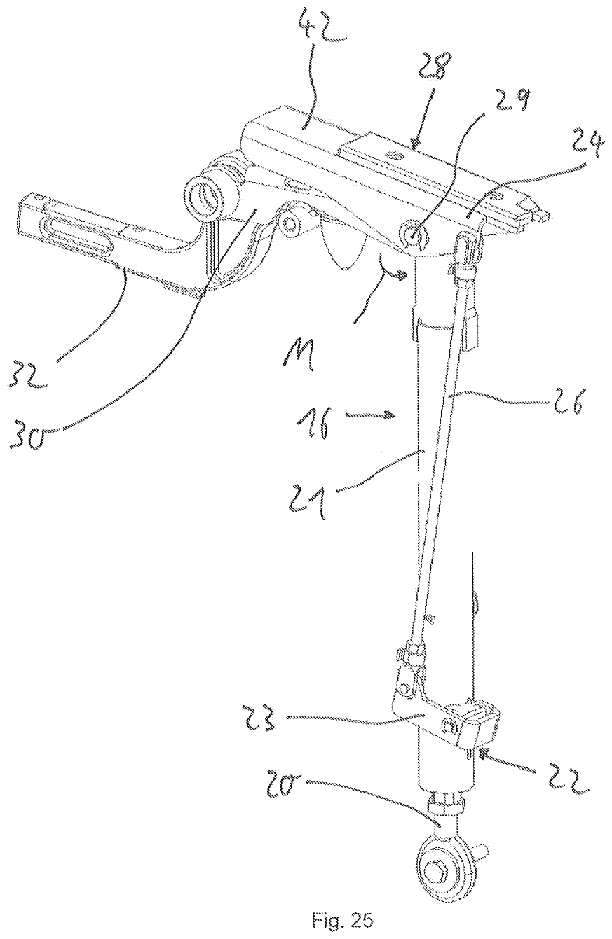

The second embodiment of the lift device, shown in FIG. 21, corresponds substantially to the previously described first embodiment, and reference is made to the above descriptions in their entirety for the description of its structure and manner of operation. The following description relates substantially to the differences from the first embodiment. Slider 28 is mounted rotatably or pivotably by rotary joint 29 on telescopic rod 16, in particular of its upper outer rod 21. Slider 28 can also be referred to as a sliding shoe and can be brought into contact with sub-arm 12 of support arm 10 and slide along its surface. Slider 28 is also attached rotatably or pivotably by a rotary joint 29 to telescopic rod 16, in particular to its upper, outer rod 21, such that slider 28 can be positioned in different rotational positions relative to support arm 10. Due to its weight balance, slider 28 acquires a torque when not in contact with support arm 10, as it is so designed that its weight on one side of rotary joint 29 is greater than its weight on the other side. As the figures show, a section 42 on one side of rotary joint 29 is longer and/or heavier than the section 44 at the opposite end. Due to the weight balance of slider 28 and thus due to a weight force, a torque M (FIGS. 23, 24 and 25) is produced on slider 28 when slider 28 is freed from support arm 10. Due to slider 28 being coupled to the rod or pull rod 26, locking means 22, or more precisely pawl 22, is then brought or biased into a locking position in such a way that roll-over flap 4 is secured in the locking position and does not drop down.

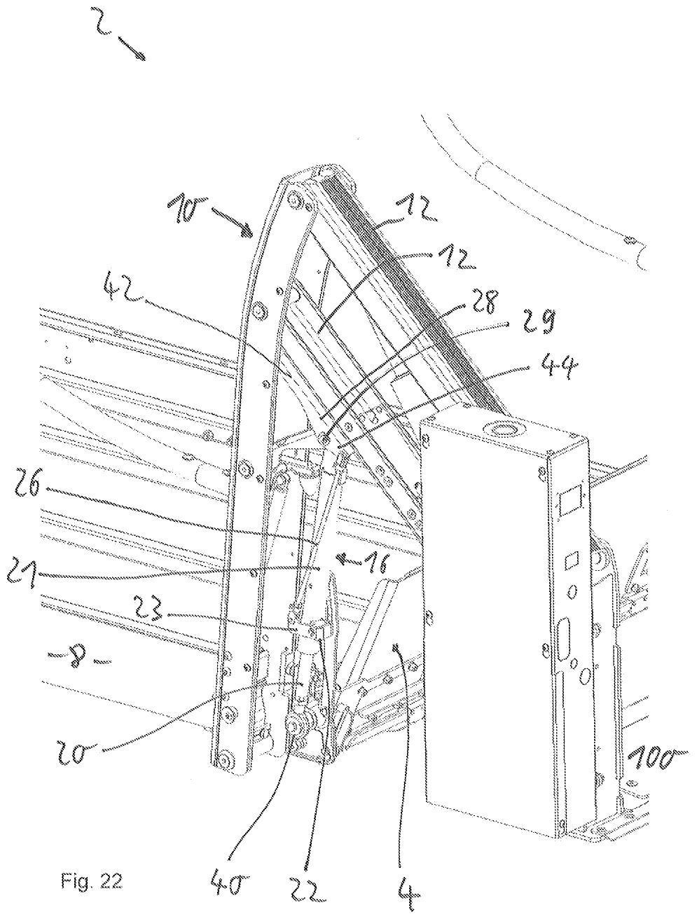

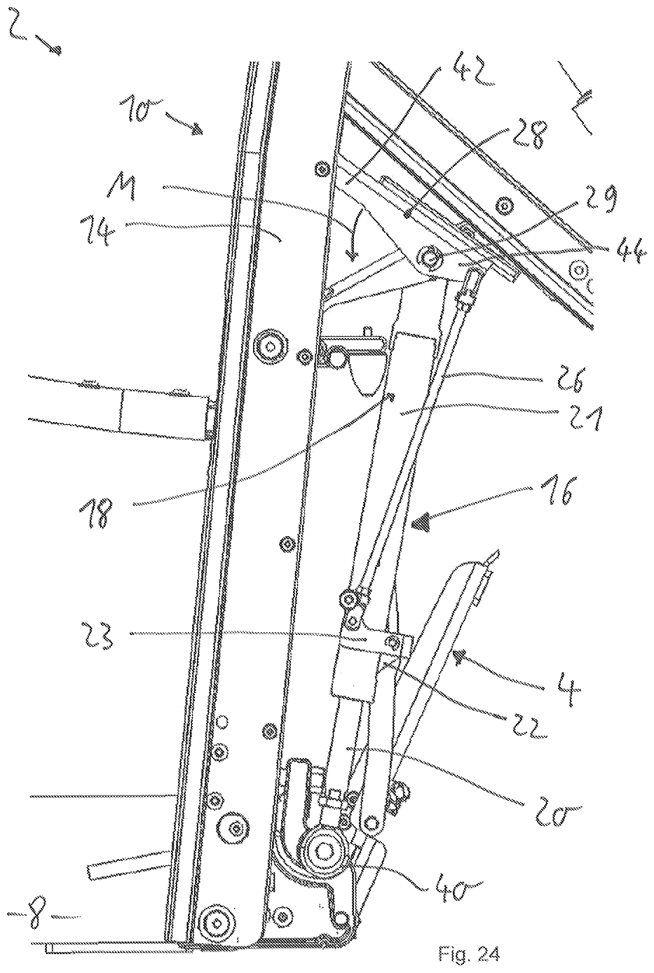

As illustrated by FIGS. 22-25 in particular, section 42 of slider 28 is longer and projects further outwards from rotary joint 29 than section 44 of slider 28, thus producing a torque M in the counter-clockwise direction, as shown by arrow M in the figures. In addition to its length, section 42 can also accommodate a greater mass than section 44, or a material with higher density, for example a high-density metal such as lead; this is an option, but not a necessity. The geometric design alone could be sufficient to produce a torque M in the counter-clockwise direction in the embodiment shown in the figures, with the result that, due to its coupling to rod 26, the pawl 22 arranged on pawl holder 23 is brought into the locking position such that telescopic rod 16 is locked due to rods 20 and 21 being hindered in their movement relative to each other, such that roll-over flap 4 is ultimately locked in its upper, passive locking position as shown in FIGS. 21 and 24.

The embodiments described above are only descriptions of preferred embodiments of the present invention, and are not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. A lift device for vehicles for wheelchair users, comprising:
a roll-over flap, wherein the roll-over flap is mounted rotatably relative to a lifting platform,
the lifting platform for loading with a load,
a support arm for raising and lowering the load to a desired position,
wherein the support arm has a first sub-arm and a second sub-arm which are rotatably coupled to one another, and wherein the second sub-arm of the support arm is rotatably connected to the lifting platform and the roll-over flap,
wherein the lift device is configured to extend or retract the roll-over flap and to lock the roll-over flap in at least one position, wherein the extending or retracting and the locking are carried out according to the position of the lifting platform and the support arm,
the lift device further comprising:
a telescopic rod that is configured with a first inner rod, a second outer rod, and a spring, and
a locking means, wherein the locking means is disposed on the telescopic rod and is adapted to lock the roll-over flap,
wherein the locking means is designed as a pawl, and the pawl engages with the telescopic rod in such a way during locking that the first inner rod of the telescopic rod is no longer movable relative to the second outer rod, and the inner rod of the telescopic rod has a projection or piston, wherein the pawl locks the projection or piston during locking.

2. A lift device for vehicles for wheelchair users, comprising:
a roll-over flap, wherein the roll-over flap is mounted rotatably relative to a lifting platform,
the lifting platform for loading with a load,
a support arm for raising and lowering the load to a desired position,
wherein the support arm has a first sub-arm and a second sub-arm which are rotatably coupled to one another, and wherein the second sub-arm of the support arm is rotatably connected to the lifting platform and the roll-over flap,
wherein the lift device is configured to extend or retract the roll-over flap and to lock the roll-over flap in at least one position, wherein the extending or retracting and the locking are carried out according to the position of the lifting platform and the support arm,
wherein the locking of the roll-over flap is caused by a weight balance of a component that exerts a torque on the component, which moves and/or biases a locking means into a locking position to lock the roll-over flap in a locked position.

3. The lift device according to claim 1, wherein, the lift device has a pull rod which is configured to actuate the locking means according to an orientation of the support arm.

4. The lift device according to claim 3, further comprising is a stop member with a slider, which is rotatably connected to the telescopic rod and the pull rod and is rotatably connected via a bar to the second sub-arm of the support arm,
wherein the stop member with a slider rests against the first sub-arm of the support arm and, by changing an angle (α) between the first and second sub-arms of the support arm, transfers a force to the pull rod, thus actuating the locking means.

5. The lift device according to claim 4, wherein the slider is attached rotatably or pivotably by a rotary joint to the telescopic rod such that the slider can be positioned in different rotational positions relative to the support arm.

6. The lift device according to claim 5, wherein a section of the slider on one side of the rotary joint is longer and/or heavier than the section at an opposite end of the slider.

7. The lift device according to claim 4, further comprising:
a handle to hold onto for the person or load to be lifted, and which is attached, with limited rotatability relative to the bar and the second sub-arm of the support arm, at an attachment point of the bar to the second sub-arm of the support arm.

8. The lift device according to claim 1, further comprising:
a roll-over flap guide which is rotatably connected to the telescopic rod and the roll-over flap.

9. The lift device according to claim 8, wherein the roll-over flap guide has an elongate hole and is connected to the telescopic rod via the elongate hole.

10. A vehicle for transporting persons with reduced mobility, having a lift device for wheelchair users, comprising:
a roll-over flap, wherein the roll-over flap is mounted rotatably relative to a lifting platform,
the lifting platform for loading with a load,
a support arm for raising and lowering the load to a desired position,
wherein the support arm has a first sub-arm and a second sub-arm which are rotatably coupled to one another, and wherein the second sub-arm of the support arm is rotatably connected to the lifting platform and the roll-over flap,
wherein the lift device is configured to extend or retract the roll-over flap and to lock the roll-over flap in at least one position, wherein the extending or retracting and the locking are carried out according to the position of the lifting platform and the support arm,
wherein the lift device further comprises:
a telescopic rod that is configured with a first inner rod, a second outer rod, and a spring, and
a locking means, wherein the locking means is disposed on the telescopic rod and is adapted to lock the roll-over flap,
wherein the locking means is designed as a pawl, and the pawl engages with the telescopic rod in such a way during locking that the first inner rod of the telescopic rod is no longer movable relative to the second outer rod, and the inner rod of the telescopic rod has a projection or piston, wherein the pawl locks the projection or piston during locking.

11. The lift device according to claim 2, wherein the lift device has a pull rod which is configured to actuate the locking means according to an orientation of the support arm.

12. The lift device according to claim 11, wherein the component is a stop member with a slider, which is rotatably connected to a telescopic rod of the lift device and to the pull rod and is rotatably connected via a bar to the second sub-arm of the support arm,
wherein the stop member with a slider rests against the first sub-arm of the support arm and, by changing an angle (α) between the first and second sub-arms of the support arm, transfers a force to the pull rod, thus actuating the locking means.

13. The lift device according to claim 12, wherein the slider is attached rotatably or pivotably by a rotary joint to the telescopic rod such that the slider can be positioned in different rotational positions relative to the support arm.

14. The lift device according to claim 13, wherein a section of the slider on one side of the rotary joint is longer and/or heavier than the section at an opposite end of the slider.

15. The lift device according to claim 12, further comprising:
a handle to hold onto for the person or load to be lifted, and which is attached, with limited rotatability relative to the bar and the second sub-arm of the support arm, at an attachment point of the bar to the second sub-arm of the support arm.

16. The lift device according to claim 2, further comprising:
a roll-over flap guide which is rotatably connected to a telescopic rod of the lift device and to the roll-over flap.

17. The lift device according to claim 16, wherein the roll-over flap guide has an elongate hole and is connected to the telescopic rod via the elongate hole.
